(19) United States
(12) Patent Application Publication
(10) Pub. No.: US 2026/0163094 A1
(43) Pub. Date: Jun. 11, 2026

(54) RECYCLING AND UPCYCLING BATTERY ANODE MATERIALS

(71) Applicant: Princeton NuEnergy Inc., Bordentown, NJ (US)

(72) Inventors: Jinyun Liao, Newtown, PA (US); Zhiqian Wang, Florence, NJ (US); Chao Yan, Princeton, NJ (US); Xiaofang Yang, Ambler, PA (US)

(73) Assignee: Princeton NuEnergy Inc., Bordentown, NJ (US)

(21) Appl. No.: 19/181,260

(22) Filed: Apr. 16, 2025

Related U.S. Application Data
(63) Continuation of application No. PCT/US2023/082773, filed on Dec. 6, 2023.
(60) Provisional application No. 63/386,242, filed on Dec. 6, 2022.

(51) Int. Cl. H01M 10/54; B09B 3/40; B09B 3/80; B09B 101/16

(52) U.S. Cl. CPC H01M 10/54; B09B 3/40; B09B 3/80; B09B 2101/16

(57) ABSTRACT

One or more aspects of the present disclosure provides methods for recycling and upcycling battery anode materials. The methods include producing raw anode materials by processing spent battery materials containing a first anode material; purifying the raw anode materials; and generating a second anode material using the purified raw anode materials. In some embodiments, the first anode material includes graphite. The second anode material includes a graphite-silicon composite and/or a graphite-silicon oxide composite. The second anode material may be battery-grade anode materials that can be directly used in the electrodes of new batteries.

### CROSS-REFERENCE TO RELATED APPLICATIONS

This application is a continuation of international application No. PCT/US23/82773, entitled “RECYCLING AND UPCYCLING BATTERY ANODE MATERIALS,” filed Dec. 6, 2023, which claims the benefits of U.S. Provisional Patent Application No. 63/386,242, entitled “RECYCLING AND UPCYCLING BATTERY ANODE MATERIALS,” filed Dec. 6, 2022, each of which is incorporated herein by reference in its entirety.

### GOVERNMENT SUPPORT STATEMENT

This invention was made with government support under Grant DE-SC0020868 awarded by the Department of Energy. The government has certain rights in the invention.

### TECHNICAL FIELD

The present application generally relates to battery recycling, and more particularly, to recycling and upcycling graphite anode materials for spent batteries.

### BACKGROUND

Lithium-ion batteries (LIBs) are widely used in many electrical devices, vehicles, etc. Spent LIBs may result in environmental problems and resource waste. End-of-life LIBs may become important secondary sources for various materials used in the production of new batteries. Decreasing the cost of recycling and improving the recycling rate could thus significantly reduce the life cycle cost of LIBs, avoid material shortages, lessen the environmental impact of new material production, and provide low-cost active materials for the manufacturing of new batteries. With the increase in cell production expected in the next decade, primary scrap from production is another key source for global recycling efforts.

Most research is focused on the recycling of metal materials in the cathode electrode. There are few reports on the recovery and utilization of anode graphite materials in spent LIBs. With the shortage of resources in modern society and the increase in production costs, graphite, as a common raw material in the field of production, has a wide range of application values. The recycling and regeneration of anode graphite in spent batteries cannot be ignored.

However, the aged materials are usually 5 to 10 years older than the current materials. The regenerated anode materials may not meet new market needs due to improvements in electrode material properties and emerging new chemistries.

Developing an efficient recycling and upcycling process that recovers anode materials in high-value form for sale back to manufacturers is key to encouraging LIB recycling. An efficient anode recycling and upcycling infrastructure may lower the cost of new batteries and increase the use of recycled battery materials.

Silicon-graphite composite materials have garnered significant attention as a potential replacement for graphite in commercial LIBs. However, these materials face challenges in addressing the volume expansion of silicon, a prominent issue that can hinder battery performance and longevity. Spent graphite emerges as a promising candidate for the low-cost production of high-performance silicon-graphite composites. Its porous structures, if refined to achieve desired pore uniformity and density and well combined with silicon, can effectively mitigate the volume expansion of silicon.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In accordance with some embodiments of the present disclosure, methods for battery recycling are provided. The methods include purifying raw anode materials, including a first anode material, and generating a second anode material using the purified raw anode materials by synthesizing the second anode material using the first anode material and one or more precursors containing silicon. The raw anode materials are produced from spent batteries or other graphite sources. The first anode material includes graphite. The second anode material includes a graphite-silicon composite and/or a graphite-silicon oxide composite.

In some embodiments, the methods further include producing the raw anode materials by separating a plurality of components of the spent battery materials, wherein the plurality of components of the spent battery materials includes the raw anode materials and raw cathode materials.

In some embodiments, purifying the raw anode materials includes removing one or more impurities from the raw anode materials, and wherein the impurities include at least one of metals, metal oxides, inorganic impurities, or organic impurities.

In some embodiments, purifying the raw anode materials includes performing a plasma purification process to remove inorganic impurities or organic impurities from the raw anode materials.

In some embodiments, generating the second anode material using the first anode material and one or more precursors containing silicon includes at least one of: coating the one or more precursors including silicon on the first anode material or embedding the one or more precursors including silicon in the first anode material.

In some embodiments, the one or more precursors containing silicon include Si particles with a diameter of 1 nm-1000 nm.

In some embodiments, the one or more precursors containing silicon include at least one of trimethylsilanol, hexamethyldisiloxane, hexamethylcyclotrisiloxane, tetramethyldisiloxane, triethylsilanol, octamethyltrisiloxane, decamethyltetrasiloxane, hexamethyldisiloxane, silane, dichlorosilane, trichlorosilane, or silicon tetrachloride.

In some embodiments, the methods further include processing the second anode material in a thermal process under a controlled atmosphere.

In some embodiments, the controlled atmosphere includes at least one of N₂ or Ar.

In some embodiments, generating the second anode material using the purified raw anode materials further includes performing surface activation on the purified raw anode materials prior to synthesizing the second anode material using the first anode material and one or more precursors including silicon.

In some embodiments, performing surface activation on the purified raw anode materials includes adding functional groups on the first anode material.

In some embodiments, performing surface activation on the purified raw anode materials further includes producing porous graphite anode materials using the purified raw anode materials.

In some embodiments, synthesizing the second anode material using the first anode material and the one or more precursors including silicon includes generating the second anode material by processing the surface-activated anode materials with the one or more precursors including silicon in a thermal process.

In some embodiments, a thermal treatment temperature of the thermal process is between about 700° C. and about 2000° C. In some embodiments, an atmosphere gas in the thermal process includes at least one of N₂ or Ar.

In some embodiments, the methods further include regenerating the first anode material contained in the raw anode materials by processing the purified raw materials in a thermal process.

In some embodiments, a thermal treatment temperature of the thermal process is between about 700° C. and about 2000° C., and wherein an atmosphere gas in the thermal process includes at least one of H₂, N₂, or Ar. In some embodiments, the atmosphere gas further includes one or more of CH₄, C₂H₂, C₂H₄, C₃H₆, and C₃H₈.

According to one or more aspects of the present disclosure, a system for battery recycling is provided. The system includes a purification module that purifies raw anode materials including a first anode material, wherein the raw anode materials are produced from spent batteries, and wherein the first anode material includes graphite; and an anode material generator that generates a second anode material using the purified raw anode materials, wherein the anode material generator synthesizes the second anode material using the first anode material and one or more precursors including silicon, wherein the second anode material includes a graphite-silicon composite.

In some embodiments, the second anode material includes at least one of a graphite-silicon composite or a graphite-silicon oxide composite.

In some embodiments, the anode material generator further performs surface activation on the purified raw anode materials prior to synthesizing the second anode material using the first anode material and one or more precursors including silicon.

### BRIEF DESCRIPTION OF THE DRAWINGS

FIG. 1 is a block diagram illustrating a system for anode recycling and upcycling in accordance with some embodiments of the present disclosure.

FIG. 2 is a block diagram illustrating an example purification module in accordance with some embodiments of the present disclosure.

FIG. 3 is a block diagram illustrating an example anode upcycling module in accordance with some embodiments of the present disclosure.

FIGS. 4A, 4B, and 4C show SEM (Scanning Electron Microscope) images of example raw anode materials, purified raw anode materials, and regenerated first anode materials, respectively, in accordance with some embodiments of the present disclosure.

FIGS. 5A and 5B are EDX spectra of example graphite anode materials before and after purification, respectively, in accordance with some embodiments of the present disclosure.

FIGS. 6A-6C show the comparison of electrochemical performance between commercial graphite and regenerated graphite.

FIG. 7A shows SEM images of example upcycled graphite-silicon composites in accordance with some embodiments of the present disclosure.

FIG. 7B illustrates EDX mappings of example upcycled graphite-silicon composites in accordance with some embodiments of the present disclosure.

FIG. 8 shows charge/discharge profiles of example upcycled graphite-silicon composite anode materials.

FIG. 9 is a flow diagram illustrating a method for anode recycling and upcycling in accordance with some embodiments of the present disclosure.

### DETAILED DESCRIPTION

Aspects of the disclosure provide mechanisms (e.g., systems, apparatuses, methods, etc.) for recycling and upcycling anode materials for spent batteries. As referred to herein, a battery may be any electric storage device. In some embodiments, the battery may be a lithium-ion battery (LIB). The mechanisms described herein may process aged batteries and produce repaired and/or upgraded anode materials that may be used in anode electrodes in new batteries.

Recycling LIBs may involve discharging spent LIBs and separating spent graphite using physical methods such as dismantling, crushing, screening, and other mechanical processes. The separated raw graphite anode materials may be processed to produce recycled anode materials (e.g., by direct regeneration of graphite) and/or upcycled anode materials (e.g., by upgrading the graphite anode materials to graphite-based materials with additional functions desirable for energy and environmental applications).

The raw graphite materials obtained via the separation of the raw graphite materials from other components of the spent batteries may not be able to meet the standard of the battery industry due to the impurities and structural defects in the graphite materials. Existing techniques for recycling graphite anode materials from spent batteries typically involve processing the raw graphite materials utilizing hydrometallurgy and/or pyrometallurgy processes. However, both pyrometallurgical and hydrometallurgical processes are energy-intensive processes that may generate environmental pollutants (e.g., furans, dioxins, and highly acidic wastewater).

The present disclosure provides an end-to-end process for anode-to-anode direct recycling and upcycling of aged anode materials. The end-to-end process may involve pre-processing of spent lithium-ion batteries, component separation and purification of raw anode materials, and direct regeneration and upgrading of anode materials. The end-to-end process may further involve a purification and regeneration process to directly recycle aged graphite anode materials. The end-to-end process may further involve a surface activation process to facilitate the integration between surface-activated graphite and silicon precursor for direct upcycling to produce Gr-Si composite anode materials.

According to one or more aspects of the present disclosure, a system for battery graphite anode materials direct recycling and upcycling is provided. The system may process spent batteries and may produce regenerated and/or upgraded anode materials that may be used in electrodes in new batteries. For example, the system may separate raw anode materials from spent battery materials. The raw anode materials may include one or more first anode materials contained in the spent battery materials (e.g., graphite), impurities, etc. The raw anode materials may then be purified by removing the impurities. The purified raw anode materials may be processed to generate anode materials that may be directly used in the electrodes of new batteries (battery-grade anode materials). For example, the first anode materials contained in the purified raw anode materials may be regenerated (e.g., recycled) as battery-grade anode materials. As another example, one or more second anode materials may be generated using the first anode materials. In some embodiments, the second anode materials may include one or more graphite-silicon (Gr-Si) composites and/or graphite-silicon oxide (Gr-SiOₓ) composites synthesized using the first anode materials and precursors including silicon.

Gr-Si and Gr-SiOₓ composite materials are promising anode materials for commercial LIBs. However, existing solutions for producing Gr-Si anode materials fail to provide a solution for reducing the volume expansion of silicon. The spent graphite materials may be used for the low-cost production of high-performance Gr-Si composites. The mechanisms described herein may produce high-energy Gr-Si composite anode materials using aged graphite anode materials, enabling anode-to-anode direct upcycling.

The direct recycling/upcycling of graphite anode materials using the disclosed methods will increase the commercial viability of lithium-ion batteries and reduce battery costs, thus accelerating the electrification of transportation and large-scale energy storage for renewable energy. The upcycled Gr-Si-based composite materials and/or Gr-SiOx-based composite materials may subsequently undergo supplemental tailored surface optimization to facilitate electronic contact, enhance rate capability, and improve cycling stability. Accordingly, the mechanisms described herein may enable an upcycled, “value-added” anode that selectively exploits the engineered value of end-of-life graphite, while reducing downstream remanufacturing requirements.

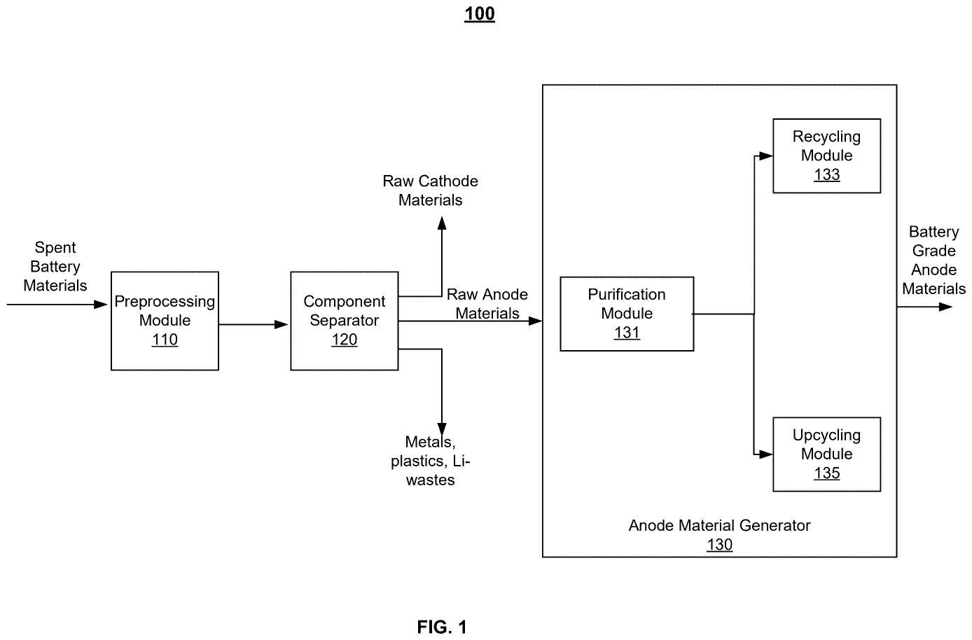

FIG. 1 is a schematic diagram illustrating an example 100 of a system for battery recycling. As shown, system 100 may include a preprocessing module 110, a component separator 120, and an anode material generator 130. System 100 may include more or fewer modules without loss of generality. For example, two of the modules may be combined into a single module, or one of the modules may be divided into two or more modules.

The preprocessing module 110 may process spent battery materials to produce preprocessed spent battery materials for further processing. For example, the preprocessing module 110 may include a battery disassembly system that can disassemble the spent batteries to remove the packaging materials of the spent batteries. The package materials (e.g., plastics, metals, etc.) may be recycled. The battery cores of the spent batteries may be disassembled using a shredder and/or a crusher into small pieces. For example, the battery cores may be shredded in an N₂ environment. In one implementation, the spent batteries may be discharged prior to being processed by the preprocessing module. In some embodiments, preprocessing the spent battery materials may include removing electrolytes from the spent battery materials, collecting packing plastics and separator membranes, powder detachment for black mass collection, etc.

The component separator 120 may process the preprocessed spent battery materials produced by the preprocessing module 110 to separate the components of the spent battery materials. The separated components of the spent battery materials may include raw cathode materials, raw anode materials, current collector metals, separator plastics, electrolytes, etc. The cathode materials may include lithium-based layered metal oxides (e.g., LiCoO₂, LiNiO₂, LiMnO₂, LiNiCoMnO₂, LiNiCoAlO₂, etc.). The raw anode materials may include one or more first anode materials contained in the spent battery materials, impurities (e.g., metal oxides, metals, inorganic impurities, organic impurities, etc.), etc. The first anode materials may be and/or include graphite. The component separator 120 may include one or more magnetic separators that may separate metals from the spent battery materials, vibratory screens that can separate particles of powders of cathode materials and powders of anode materials from large pieces, etc. In some embodiments, the component separator 120 may include one or more reactors for processing the preprocessed spent battery materials and generating the raw cathode materials, raw anode materials, etc.

The raw anode materials separated from the other components of the spent batteries may be provided to the anode material generator 130 for processing. The anode material generator 130 may generate one or more anode materials that may be used as electrodes of new batteries (also referred to as the “battery-grade anode materials”). For example, the anode material generator 130 may regenerate the first anode material contained in the raw anode materials. As another example, the anode material generator 130 may generate one or more second anode materials using the first anode material contained in the raw anode material. In some embodiments, the second anode materials may include one or more composite anode materials, such as Gr-Si composites, Gr-SiOₓ composites, etc.

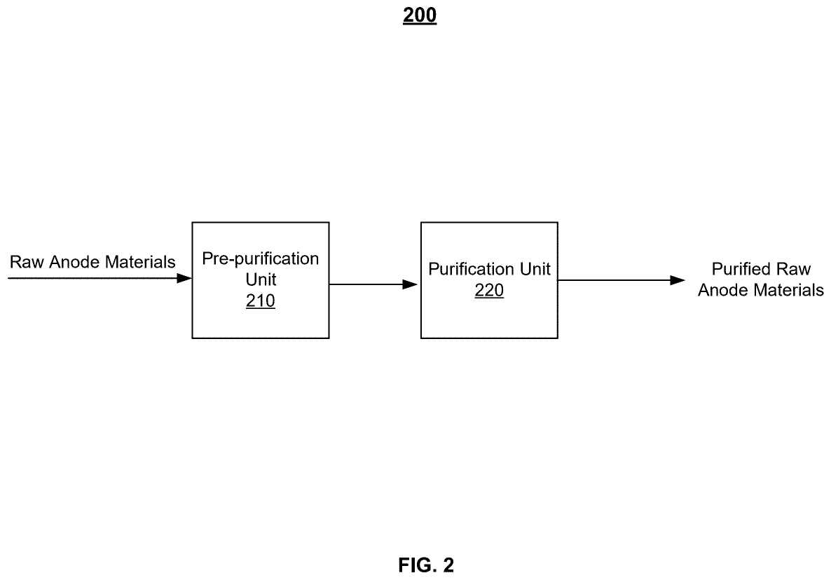

As shown in FIG. 1, the anode material generator 130 may include a purification module 131, an anode material recycling module 133, and an anode material upcycling module 135. The purification module 131 may remove one or more impurities from the raw anode materials and produce purified anode materials (e.g., graphite particles). Examples of the impurities may include metallic impurities (e.g., Li, Co, Mn, Ni, Al, Cu, Zn, Fe), metal oxides (e.g., Al₂O₃, CuO), impurities including fluorine (F) and/or phosphorus (P) (e.g., LiF, Li₃PO₄), etc. In some embodiments, the impurities include cathode materials from the spent battery materials. The purification module 131 may further perform a plasma purification process to remove inorganic impurities or organic impurities from the raw anode materials. In some embodiments, the purification module 131 may include one or more components of the purification module 200 as described in connection with FIG. 2 below. In some embodiments, the plasma purification process may be implemented using the techniques as described in PCT/US2021/060502, entitled “SYSTEMS AND METHODS FOR LITHIUM ION BATTERY CATHODE MATERIAL RECOVERY, REGENERATION, AND IMPROVEMENT,” filed Nov. 23, 2021, which is incorporated herein by reference in its entirety.

The purified anode materials may then be processed by the recycling module 133 and/or the upcycling module 135 to produce anode materials that may be used in the electrodes of new batteries (battery-grade anode materials). The anode material recycling module 133 may regenerate the first anode materials contained in the spent battery materials. The regenerated first anode materials may be battery-grade anode materials that may be used in electrodes in new batteries. For example, the anode material recycling module 133 may process the graphite anode materials in a thermal process under a controlled atmosphere to produce battery-grade anode materials for the manufacturing of new batteries. In some embodiments, the thermal treatment temperature may be between about 700° C. and about 2000° C. In certain aspects, the controlled atmosphere gas may include H₂, N₂, Ar, etc., and combinations thereof. In some embodiments, the atmosphere gas does not include oxygen. To enhance the bonding strength between the introduced Si compounds and the porous graphite host, carbon-containing compounds such as alkanes, alkenes, and alkynes can be introduced into the gas atmosphere as additional carbon sources. Examples of suitable gases include methane (CH₄), ethyne (C₂H₂), ethylene (C₂H₄), propane (C₃H₆), and propene (C₃H₈). These gases can be introduced in concentrations ranging from 0.1% to 20% by volume.

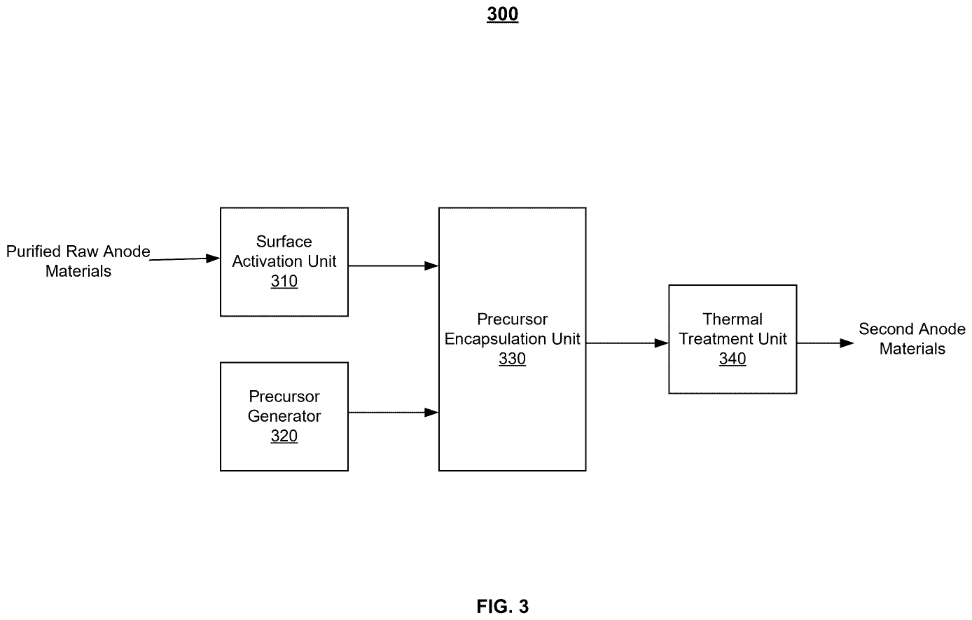

The anode material upcycling module 135 may produce one or more second anode materials using the first anode materials. For example, the anode material upcycling module 135 may generate one or more Gr-Si composites and/or Gr-SiOₓ composites using purified graphite materials and/or suitable precursors containing silicon. In some embodiments, the anode upcycling module 135 may include one or more components of the anode upcycling module 300 as described in connection with FIG. 3 below.

FIG. 2 is a block diagram illustrating an example 200 of a purification module in accordance with some embodiments of the present disclosure. As shown, the purification module 200 may include a pre-purification unit 210, a plasma purification unit 220, and/or any other suitable component for purifying raw anode materials separated from spent batteries for further recycling and/or upcycling processes described herein. The purification module 200 may purify raw anode materials separated from spent batteries (e.g., the raw anode materials produced by the component separator 120 of FIG. 1) and may produce purified anode materials for further recycling and/or upcycling processes. The raw anode materials may include one or more first anode materials, such as graphite materials. The purified anode materials may include purified graphite materials (e.g., graphite particles).

The pre-purification unit 210 may remove one or more impurities from the raw anode materials. For example, the pre-purification unit 210 may include one or more magnetic separators that can remove one or more metallic impurities from the separated raw anode materials. As another example, the pre-purification unit 210 may remove one or more metallic and oxide impurities using acid or base solutions. The acid may include, for example, HCl, H₂SO₄, HNO₃, H₃PO₄, etc. The base may include, for example, LiOH, NaOH, KOH, NH₄OH, etc. As a further example, the pre-purification unit 210 may include an air classification or cyclone separation system that may separate particles of metallic impurities and metal oxides by air classification or cyclone separation under reduced air pressure. The air classification or cyclone separation may be carried out using a carrier gas including O₂, air, N₂, Ar, etc. Examples of the metallic impurities include Fe, Al, Cu, etc. Examples of the metal oxide impurities include Al₂O₃, CuO, ZrO₂, LiCoO₂, LiNiCoMnO₂, LiNiCoAlO₂, etc. In some embodiments, one or more impurities may be removed by reacting the solid materials with concentrated bases in a pressure vessel and subsequent filtration. In some embodiments, one or more impurities may be removed by reacting the solid materials with concentrated acids and subsequent filtration.

In some embodiments, the impurities on anode materials may also include cathode materials. The pre-purification unit 210 may separate the cathode materials from the raw anode materials. For example, anode graphite and cathode oxides may be separated by processing the first solid materials in heavy solvents or salt solutions. The density of the solutions/solvents may be between the density of graphite (2.3 g/cm) and the density of cathode oxides (5.5-7 g/cm³). The high-density solution may be recycled for use in the next batch. Examples of high-density solutions and solvents include ZnBr₂, sodium polytungstate, or mixtures of these chemicals in solution.

The purification unit 220 may further purify the pre-purified anode materials produced by the pre-purification unit 210. For example, the plasma purification unit 220 may remove organic impurities (e.g., impurities including F and/or P) from the pre-purified graphite anode materials. In some embodiments, the purification unit 220 may include a plasmatic reactor. In some embodiments, the purification unit 220 include one or more plasma reactor as described in PCT/US2021/060502, entitled “SYSTEMS AND METHODS FOR LITHIUM ION BATTERY CATHODE MATERIAL RECOVERY, REGENERATION, AND IMPROVEMENT,” filed Nov. 23, 2021, which is incorporated herein by reference in its entirety. The purification unit 220 may cause the pre-purified anode materials to flow through a plasma region to a non-equilibrium plasma having a predetermined plasma power density for a predetermined plasma exposure time. The flow velocity, the predetermined solid-to-gas volume ratio, the predetermined plasma power density, and the predetermined plasma exposure time are collectively tuned to reduce or eliminate physically adsorbed and/or covalently bound surface impurities on the pre-purified anode materials.

In some embodiments, the predetermined flow velocity is between 2 m/s and 20 m/s. In some embodiments, the predetermined solid-to-gas volume ratio is between 0.001 and 0.1. In some embodiments, the predetermined plasma power density is between 0.3 kW and 30 kW per kilogram of the pre-purified aged graphite anode materials. In some embodiments, the predetermined plasma exposure time is between 0.05 s and 30 s. In some embodiments, the carrier gas may include O₂, air, N₂, Ar, etc., and a combination thereof.

FIG. 3 is a block diagram illustrating an example 300 of an anode upcycling module in accordance with some embodiments of the present disclosure. As shown, the anode upcycling module 300 may include a surface activation unit 310, a precursor generator 320, a precursor encapsulation unit 330, a thermal treatment unit 340, and/or any other suitable component for generating one or more second anode materials using one or more first anode materials (e.g., the purified anode materials generated by the purification module 131 and/or the purification module 200). The surface activation unit 310 can be a process reactor (e.g., a plasma reactor) for surface treatment adding function groups on the surface. The precursor generator 320 is a precursor feeder (e.g., a tank) containing solid, liquid, or gaseous Si-contained precursor. The precursor encapsulation unit 330 is a reaction section (e.g., a furnace) for interaction between graphite and Si-precursor. The thermal treatment unit 340 can be a tube furnace for thermal treatment to produce final Gr-Si or Gr-SiOₓ composite materials. The second anode material(s) produced by the anode upcycling module 300 may include one or more Gr-Si composites and/or Gr-SiOₓ composites that are battery-grade anode materials suitable for new battery manufacturing. The disclosed anode upcycling module 300 may include more or fewer units without loss of generality. For example, two of the units may be combined into a single unit or one of the units may be divided into two or more units.

The surface activation unit 310 may process the purified raw anode materials utilizing one or more surface activation methods. As described above, the purified raw anode materials include one or more first anode materials contained in the spent battery materials. The surface activation process may improve the reactivity of the first anode material with precursors containing silicon. For example, the surface activation unit 310 may add functional groups (e.g., —OH, —COOH, C═O, etc.) on the surface of the purified first anode materials (e.g., purified graphite anode materials) to accelerate the reaction and bonding between the first anode materials and other materials to be used to generate the second anode materials (e.g., precursors and/or materials containing silicon). As a more particular example, the surface activation unit 310 may perform one or more acid treatment processes to incorporate —OH groups on the surface of the purified first anode materials. The acid may include, for example, HCl, H₂SO₄, HNO₃, H₃PO₄, etc. As another example, the surface activation unit 310 may generate radicals on the surface of the first anode materials to improve the activity by performing a plasma treatment. In some embodiments, the surface activation involves using a raw anode weighing 5 kg, treated with an acid mixture consisting of a sulfuric acid solution with a concentration of 2 moles per liter (2M H₂SO₄) and a hydrochloric acid solution with a concentration of 1 mole per liter (1M HCl), in a total volume of 10 liters. This reaction may be conducted for about one hour at a temperature of 60° C. in some embodiments. After the reaction, the solid materials are filtered, washed, and then dried. For further surface activation, these purified anodes can be processed in an alkaline solution. In this step, a raw anode of 5 kg is treated with a sodium hydroxide solution (NaOH) with a concentration of 6 moles per liter (6M NaOH), using a total volume of 10 liters, for a reaction time of 1 hour at the same temperature of 60° C.

In some embodiments, the surface activation unit 310 may process the purified raw anode materials using pore-generation agents to generate porous structures in the graphite material, thereby producing porous graphite materials. The porous structure in the graphite material can provide additional surface areas and/or reaction sites for silicon precursor implantation and more space for volume expansion during charging and discharging. The porous structures may facilitate electrolyte permeation, which may lead to a greater electrode-electrolyte interface. This may provide more active sites for electrochemical and electrocatalytic reactions.

In some embodiments, the generation of the porous graphite materials may include catalytic gasification of the purified graphite materials in a reduction gas atmosphere with various metal, salt, and metal oxide catalysts. In some embodiments, the reduction gas may include hydrogen, carbon monoxide, carbon dioxide, steam, the like, or combinations thereof. In some embodiments, the catalyst may include Ni, Zn, Na, K, FeCl₃, Ni(NO₃)₂, Fe(NO₃)₃, the like, or combinations thereof. In some embodiments, an acid solution may be used to remove the any residual catalyst from the porous graphite materials. An example of this process includes mixing 1.5 kg of purified graphite with a 5-liter solution of nickel(II) nitrate (containing 10 grams of Ni(NO₃)₂·6H₂O) and stirring for 2 hours. After filtration and drying, the resultant powder is placed in a tube furnace and heated to 800° C. at a rate of 5° C./min under nitrogen (N₂) atmosphere. Once the temperature stabilizes at 800° C., liquid water is pumped into the furnace at a flow rate of 0.20 ml/min. The reaction is then carried out for a duration of about 10 hours.

In some embodiments, the concentration of the catalyst precursors may be between about 0.1 wt. % and about 50 wt. %. In some embodiments, the reduction gas concentration may be between about 0.1% and about 20% by volume. In some embodiments, the carrier gas for reduction gas may include N₂, Ar, etc., and combinations thereof. In some embodiments, the pore generation reaction temperature is between about 40° C. and about 1000°C.

In some embodiments, the surface activation can be carried out by plasma treatment. The plasma processing may be carried out using a dielectric barrier discharge (DBD) electrode positioned downstream of the particle and gas mixer and upstream of, where the DBD electrode is adapted to provide a non-equilibrium plasma to introduce radicals to the surface of the particles. In some embodiments, the plasma treatment may be performed by the purification unit 220 of FIG. 2 as described above. The gas composition for the plasma may include either single gases or combinations of argon (Ar), oxygen (O₂), water vapor (H₂O), hydrogen (H₂), and small hydrocarbon molecules (e.g., methane (CH₄), acetylene (C₂H₂), propene (C₃H₄), and propane (C₃H₆)). An example of the conditions for plasma treatment includes a raw anode feed rate of 6 kg/hr, a gas mixture containing 1% O₂ in argon, a gas flow rate of 20 m³/hr, a gas temperature of 300° C., a plasma discharge power of 6000 W, and a residence time of 30 seconds.

The precursor generator 320 may generate and/or provide one or more suitable precursors for generating the second anode material(s). The precursors may include, for example, Si-based precursors (e.g., solid precursors, liquid precursors, gaseous precursors, etc. containing Si), surface-activated graphite materials, binders with suitable solvents, etc. In some embodiments, the Si-based precursors may include one or more Si nanoparticles (e.g., Si particles with a diameter of 1 nm-1000 nm), trimethylsilanol, hexamethyldisiloxane, hexamethylcyclotrisiloxane, tetramethyldisiloxane, triethylsilanol, octamethyltrisiloxane, decamethyltetrasiloxane, etc.

In some embodiments, the concentration of the Si precursors (e.g., solid Si precursors or liquid Si precursors) may be between about 1 wt. % and about 50 wt. %. In some embodiments, the binders may include one or more of polyvinyl butyral (PVB), polyvinyl alcohol (PVA), polyethylene glycol (PEG), etc. The binder concentration may be between about 0.1 wt. % and about 20 wt. %. In some embodiments, the solvent may include water, ethanol, methanol, isopropanol, ethylene glycol, etc.

In some embodiments, the concentration of the gaseous Si precursors may be between about 1 wt. % and about 100 wt. %. In some embodiments, the Si-based gaseous precursors may include silane, dichlorosilane, trichlorosilane, silicon tetrachloride, the like, and a combination thereof. In some embodiments, the carrier gas of reduction gas may include N₂, Ar, and combinations thereof. In some embodiments, the reaction temperature is between 40° C. and 500° C.

The surface-activated first anode materials produced by the surface activation unit 310 may be provided to the precursor encapsulation unit 330 for further processing. The precursor encapsulation unit 330 may generate one or more second anode materials using the surface-activated first anode materials and the precursors provided by the precursor generator 320. The second anode materials may include one or more composite anode materials, such as Gr-Si composites, Gr-SiOₓ composites, etc. For example, the precursor encapsulation unit 330 may synthesize one or more Gr-Si composites by coating Si precursors on and/or embedding Si precursors into the first anode materials. In some embodiments, Gr-Si or Gr-SiOₓ composites may be synthesized via a spray pyrosis coating process. The coating process can be well controlled by adjusting the operation parameters including the flow rate of precursor, the nozzle configuration, the process temperature, and the carrier gas. In some embodiments, the Gr-Si composite(s) may be synthesized utilizing a sol-gel process that involves removing the remaining liquid (solvent) phase that requires a drying process, which is typically accompanied by a significant amount of shrinkage and densification. The uniformity of the composite materials produced by the sol-gel process may be well controlled by adjusting the heating rate, temperature, and stirring speed. In some embodiments, the Gr-Si composites may be synthesized utilizing a ball milling process. A ball mill is a type of grinder used to grind or blend materials. In some embodiments, the Gr-Si composites may be synthesized via a dry coating process. For example, using a hybridization system to uniformly coat Si precursors on graphite materials. The hybridization system may perform surface modification, prepare composite materials of fine particles, and carry out precise mixing using a dry powder process. The raw materials are dispersed in a high-speed airflow and processed by a mechanical impact force.

The thermal treatment unit 340 may process the second anode materials (e.g., the composite anode materials) in a thermal process under a controlled atmosphere to produce battery-grade anode materials for new battery manufacturing. In certain aspects, the thermal treatment temperature may be between about 700° C. and about 2000° C. In some embodiments, the controlled atmosphere gas may include N₂, Ar, etc.

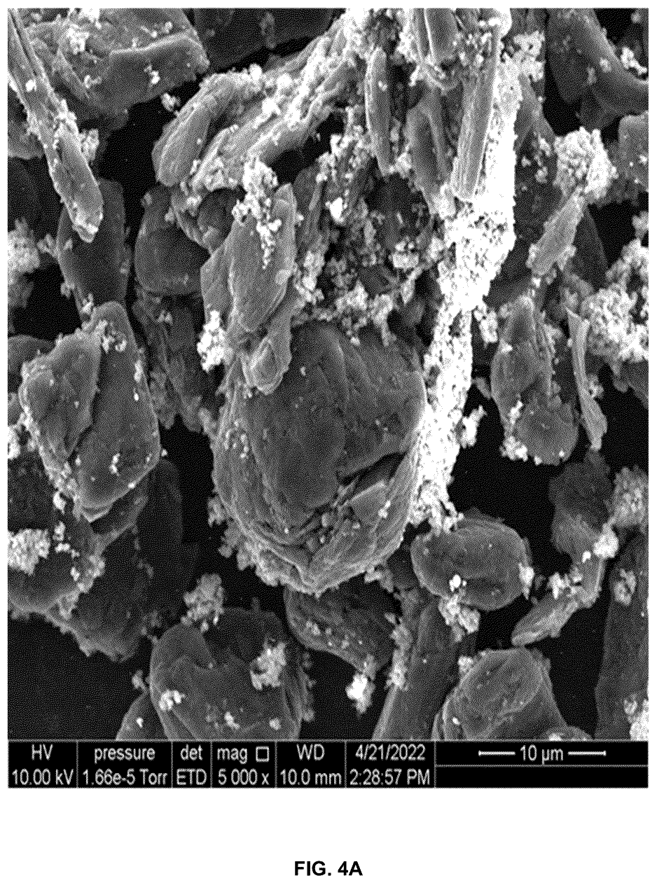

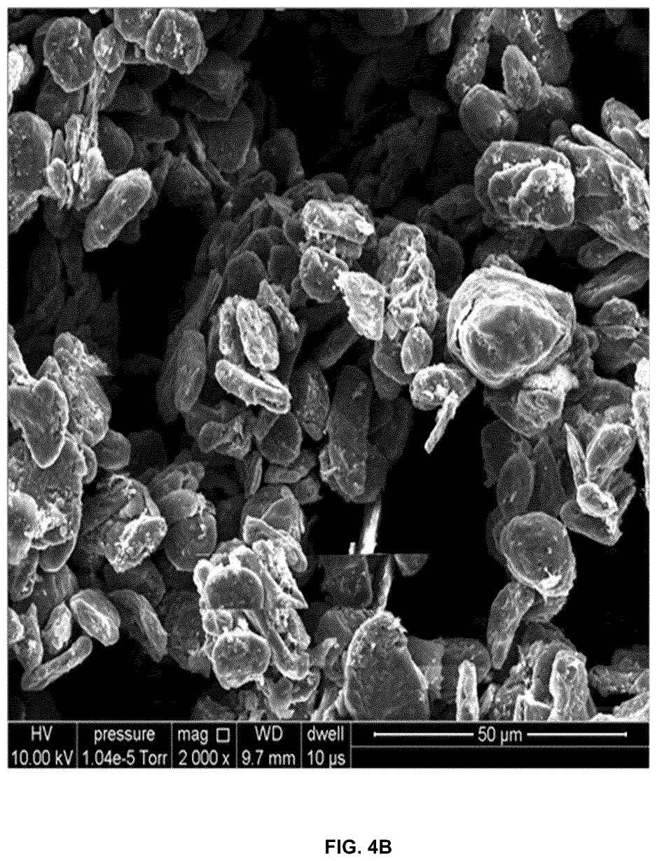

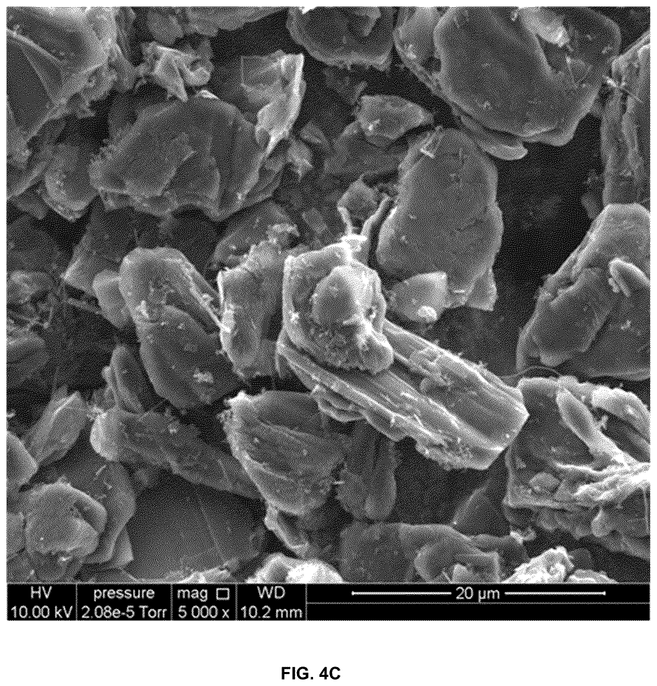

FIGS. 4A, 4B, and 4C show SEM images of example raw anode materials produced by the component separator 120 from aged LIBs, purified raw anode materials produced by the purification module 131, and regenerated first anode materials produced by the recycling module 133, respectively. As shown in FIG. 4A, the raw anode materials separated from packaging, separators, electrolytes, and current collectors of the spent LIBs include impurities. After pre-purification and plasma deep cleaning processes, purified anode materials with clean surfaces are obtained. The regenerated first anode materials are shown in FIG. 4C.

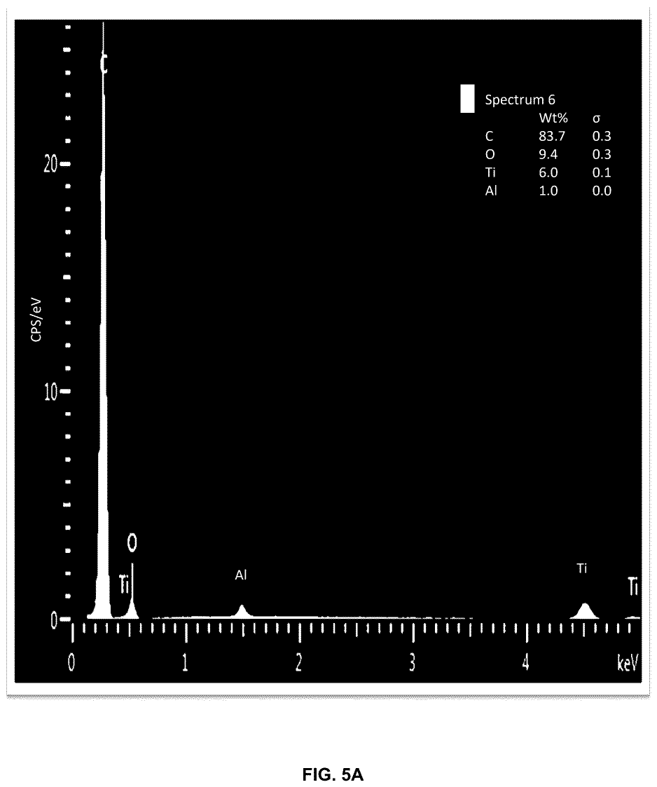

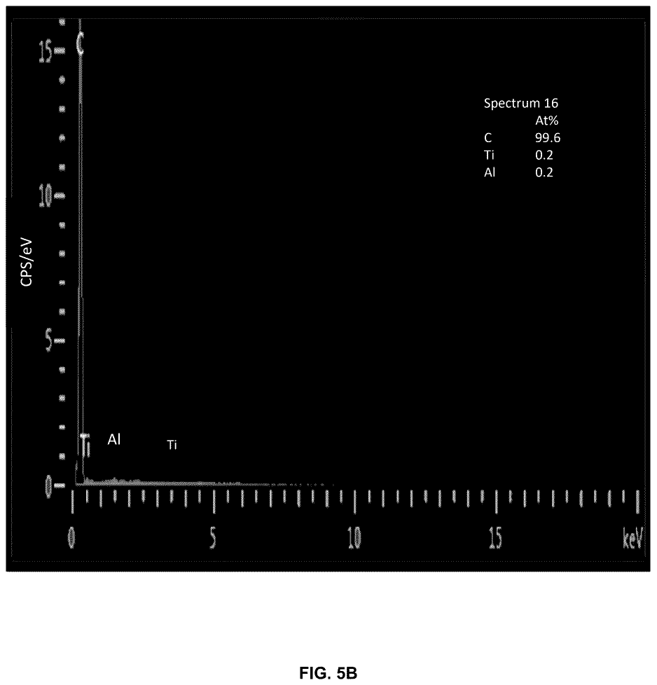

FIGS. 5A and 5B demonstrate the impurity levels of example raw anode materials before and after being purified by the purification module 131, respectively. As shown, the impurity levels of Al and Ti were significantly reduced.

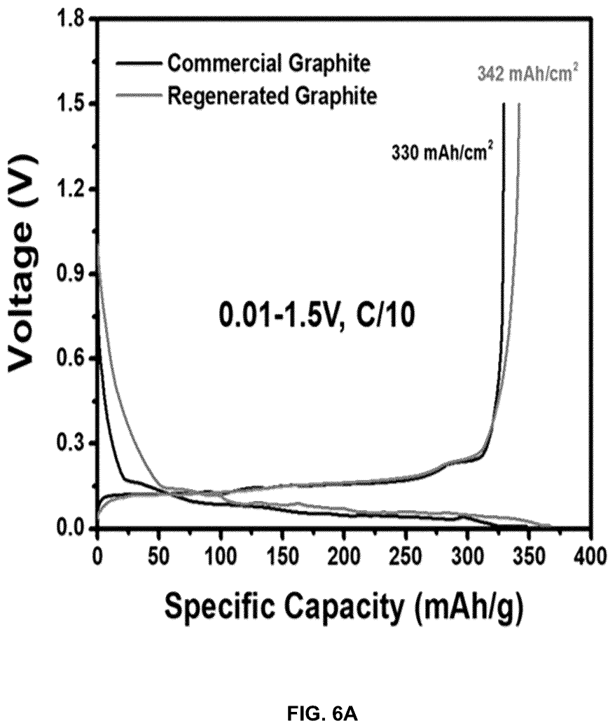

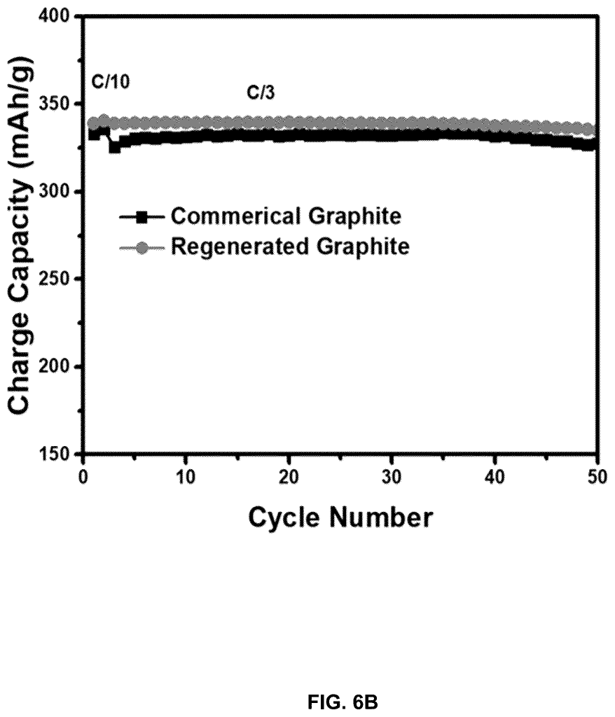

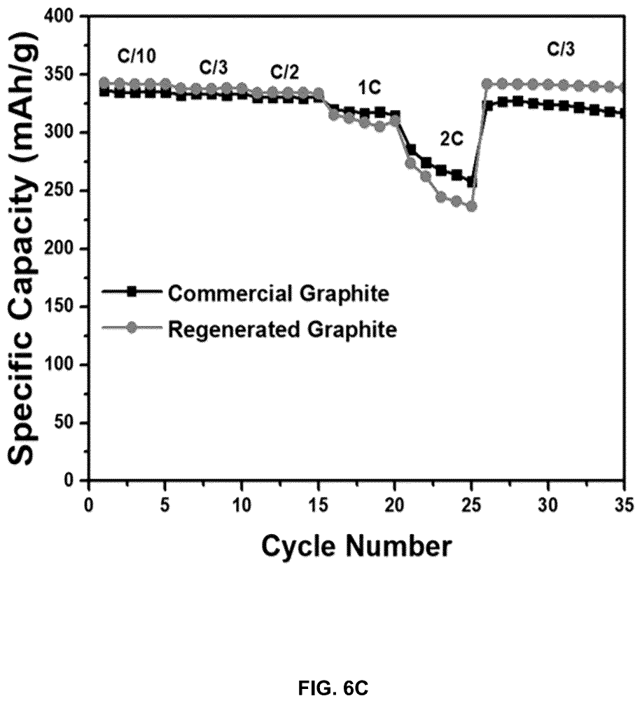

Half cells were prepared using the direct recycled graphite materials and commercial graphite materials as the working electrode, and the electrochemical test was carried out at 0.01 V-1.50 V at room temperature using lithium metal as the counter electrode. As shown in FIG. 6A, the first discharge-specific capacity of the recycled graphite and commercial graphite samples at a rate of C/10 reached 342 and 330 mAh/g, respectively. For cycling performance and rate capability testing, shown in FIG. 6B and FIG. 6C, the capacity retention of the recycled graphite sample is comparable to or higher than that of commercial graphite samples, indicating that the recycled graphite materials structure is fully recovered for new battery applications.

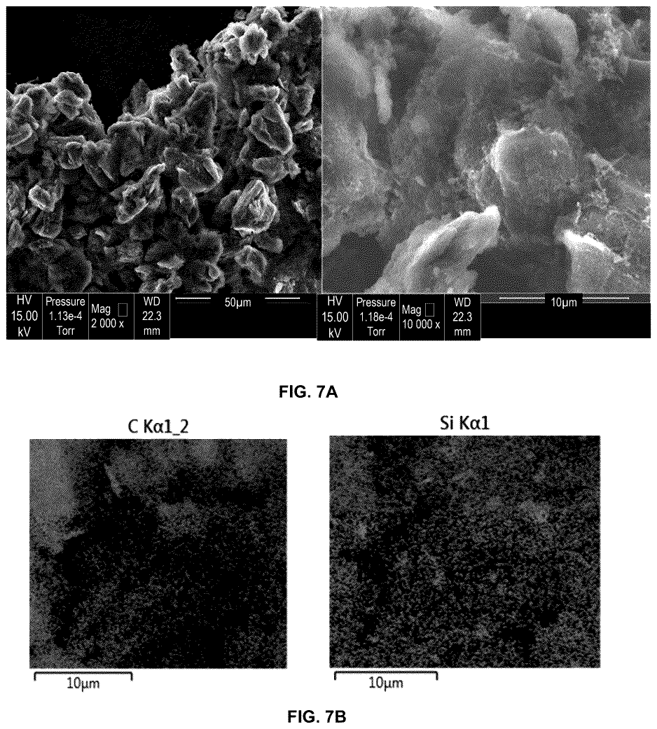

FIG. 7A illustrates SEM and EDX mapping graphs of example upcycled Gr-Si composite anode material produced by the upcycling module 135 of FIG. 3. FIG. 7A shows SEM images of upcycled Gr-Si composite generated from spent LIBs including graphite anode materials. FIG. 7B shows EDX mapping of C and Si elements on the sample in FIG. 7A. As shown in FIG. 7B, Si precursor is well coated on the surface of graphite materials. As shown, Si is uniformly distributed throughout the graphite particles.

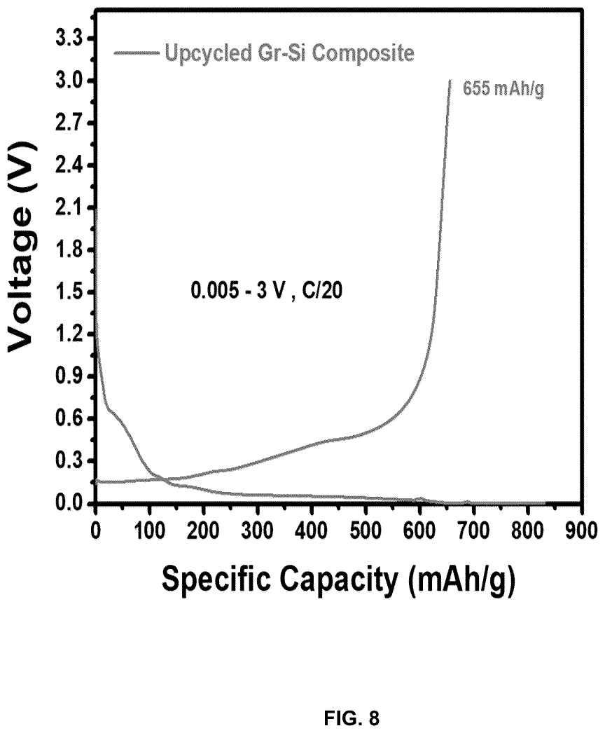

Half cells were prepared using the direct upcycled Gr-Si composite anode materials as a working electrode, and the electrochemical test was carried out at 0.005-3.0 V at room temperature using lithium metal as the counter electrode. As shown in FIG. 8, the first discharge-specific capacity of the upcycled Gr-Si composite at a rate of C/20 reached 655 mAh/g, which is much higher than the directly recycled graphite anode (342 mAh/g). The upcycled Gr-Si composite with much-improved capacity can be widely used in battery anode for high-energy battery applications.

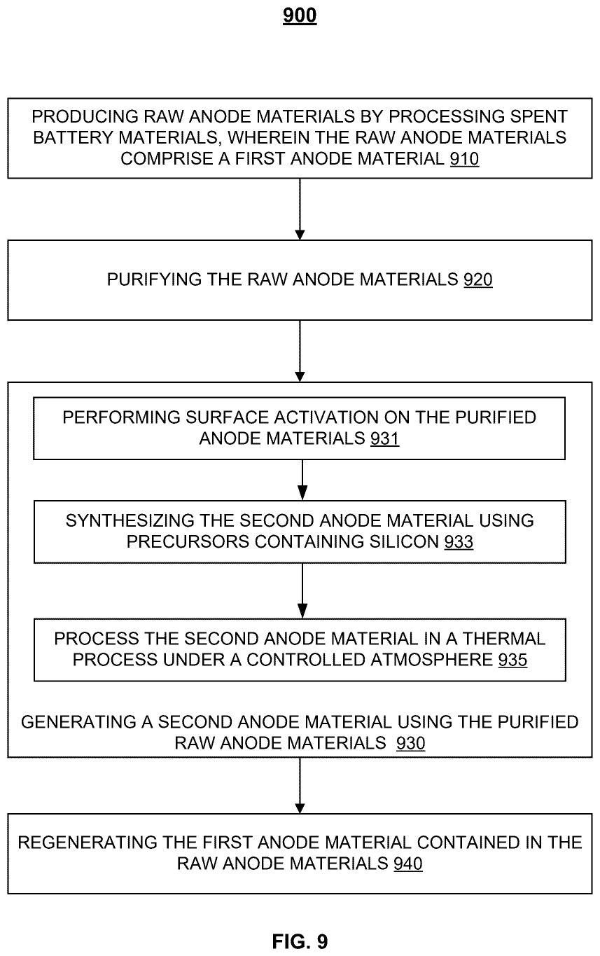

FIG. 9 is a flow diagram illustrating an example method 900 for anode recycling and upcycling in accordance with some embodiments of the present disclosure.

At 910, raw anode materials may be produced by processing spent battery materials. For example, the preprocessing module 110 and/or the component separator 120 of FIG. 1 may preprocess the spent battery materials and separate components of the spent battery materials (e.g., raw cathode materials, the raw anode materials, metals, plastics, Li-wastes, etc.) as described above. The raw anode materials may include one or more first battery materials (e.g., graphite anode materials) and one or more impurities (e.g., metals, metal oxides, inorganic impurities, organic impurities, etc.).

As an example, the size of the spent battery materials (e.g., NCM (Nickel Cobalt Manganese)-Graphite batteries) may be reduced. In some embodiments, the spent battery materials can be shredded into pieces measuring between 1 cm and 5 cm using a shredder in a nitrogen (N₂) atmosphere. The shredded batteries may be dried in a dryer at a suitable temperature for a suitable duration to remove the electrolyte. For example, the shredded batteries, weighing approximately 10 kg, may be dried in a dryer at 150° C. for 2 hours to remove the electrolyte. Membrane and packaging materials within the spent battery materials may be removed using one or more density separators. The resulting mixture contains anode and cathode electrode materials, specifically powders on current collectors. Anode and cathode powders in the spent battery materials may then be detached in a furnace at a suitable temperature (e.g., 500° C.) under a nitrogen flow for a suitable time period (e.g., about one hour). The flow rate of the nitrogen flow may be 1 m³/hour in some embodiments. After cooling, the anode powders and the cathode powders may be sieved using a vibrational screen separator. The anode materials and the cathode materials may then be separated using a density separator.

At 920, the raw anode materials may be purified. For example, one or more impurities may be purified and/or removed from the raw anode materials. The impurities may include, for example, metals, metal oxides, inorganic impurities, organic impurities, etc. The impurities may be removed by the purification module 131 of FIG. 1 and/or the purification module 200 of FIG. 2 as described above. As a more particular example, to remove impurities and enhance the quality of the graphite material, 3 kilograms of raw graphite are subjected to a purification process using 1M H₂SO₄ at a temperature of 60° C. for a duration of 2 hours. Upon completion of the reaction, the solid materials are filtered, washed, and dried to ensure their cleanliness and suitability for further processing.

In some embodiments, purifying the raw anode materials may further involve performing a plasma purification process to remove inorganic impurities or organic impurities from the raw anode materials. For example, the purified raw graphite is activated at a controlled rate of 100 grams per minute. A gas flow of 1% O₂ in Ar by volume at a flow rate of 50 liters per minute is employed. The plasma power is set to 6000 watts, and the residence time is maintained at 30 seconds. This activation step alters the surface properties of the graphite, enhancing its reactivity and suitability for subsequent steps. In some embodiments, the plasma purification process may be implemented using the techniques as described in in PCT/US2021/060502, entitled “SYSTEMS AND METHODS FOR LITHIUM ION BATTERY CATHODE MATERIAL RECOVERY, REGENERATION, AND IMPROVEMENT,” filed Nov. 23, 2021, which is incorporated herein by reference in its entirety.

At 930, a second anode material may be generated using the purified raw anode materials. The second anode material may include a graphite-silicon (Gr-Si) composite, a graphite-silicon oxide (Gr-SiOₓ) composite, etc. For example, surface activation may be performed on the purified raw anode materials at 931. In some embodiments, the surface activation unit 310 of FIG. 3 may perform surface activation on the purified raw anode materials (the purified first anode materials) as described in connection with FIG. 3 above

At 933, the second anode material may be synthesized using the first anode material and one or more precursors containing silicon. In some embodiments in which surface activation on the purified raw anode materials (the purified first anode materials) prior to synthesizing second anode materials, the second anode materials may be synthesized using the surface-activated first anode material. As an example, the precursors containing silicon may be coated on the surface-activated first anode material and/or embedded in the surface-activated first anode material. The precursors containing silicon may include Si particles with a diameter between about 1 nm and about 1000 nm. The precursors may include, for example, trimethylsilanol, hexamethyldisiloxane, hexamethylcyclotrisiloxane, tetramethyldisiloxane, triethylsilanol, octamethyltrisiloxane, decamethyltetrasiloxane, hexamethyldisiloxane, silane, dichlorosilane, trichlorosilane, silicon tetrachloride, etc. The second anode material may be synthesized by the precursor encapsulation unit 330 of FIG. 3, as described in connection with FIG. 3 above. As a more particular example, a mixture is prepared by combining 3 kilograms of activated graphite with 250 grams of Si precursor, such as trimethylsilanol, within 10 liters of aqueous solution. The mixture is vigorously stirred at a speed of 600 revolutions per minute for 2 hours, maintaining a temperature of 50° C.

At 935, the second anode material may be further processed in a thermal process under a controlled atmosphere to produce battery-grade anode materials for new battery manufacturing. The controlled atmosphere may include N₂, Ar, the like, or a combination thereof. A thermal treatment temperature of the thermal process is between about 700° C. and about 2000° C. The thermal process may be carried out, for example, by the thermal treatment unit 340, as described above in connection with FIG. 3. As more particular example, the mixture is subjected to an annealing process at a temperature of 1500° C. for a duration of 10 hours. A continuous nitrogen flow is maintained during this step to uphold an inert atmosphere. Annealing enhances the structural stability and electrochemical properties of the silicon-graphite composite material.

In some embodiments, the first anode material contained in the raw anode materials may be regenerated by processing the purified raw materials at 940. For example, the purified raw materials may be processed in a thermal process by the recycling module 133 of FIG. 1 as described above.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

The terms “approximately,” “about,” and “substantially” may be used to mean within ±20% of a target dimension in some embodiments, within ±10% of a target dimension in some embodiments, within ±5% of a target dimension in some embodiments, and yet within ±2% in some embodiments. The terms “approximately” and “about” may include the target dimension.

In the foregoing description, numerous details are set forth. It will be apparent, however, that the disclosure may be practiced without these specific details. In some instances, well-known structures and devices are shown in block diagram form, rather than in detail, in order to avoid obscuring the disclosure.

The terms “first,” “second,” “third,” “fourth,” etc. as used herein are meant as labels to distinguish among different elements and may not necessarily have an ordinal meaning according to their numerical designation.

The words “example” or “exemplary” are used herein to mean serving as an example, instance, or illustration. Any aspect or design described herein as “example” or “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an implementation” or “one implementation” means that a particular feature, structure, or characteristic described in connection with the implementation is included in at least one implementation. Thus, the appearances of the phrase “an implementation” or “one implementation” in various places throughout this specification are not necessarily all referring to the same implementation.

Whereas many alterations and modifications of the disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the disclosure.

What is claimed is:

1. A method for battery recycling and upcycling, comprising:
purifying raw anode materials comprising a first anode material, wherein the raw anode materials are produced from spent battery materials, and wherein the first anode material comprises graphite; and
generating a second anode material using the purified raw anode materials, comprising:
synthesizing the second anode material using the first anode material and one or more precursors comprising silicon.

2. The method of claim 1, wherein the second anode material comprises at least one of a graphite-silicon composite or a graphite-silicon oxide composite.

3. The method of claim 1, further comprising producing the raw anode materials by separating a plurality of components of the spent battery materials, wherein the plurality of components of the spent battery materials comprises the raw anode materials and raw cathode materials.

4. The method of claim 1, wherein purifying the raw anode materials comprises removing one or more impurities from the raw anode materials, and wherein the impurities comprise at least one of metals, metal oxides, inorganic impurities, or organic impurities.

5. The method of claim 4, wherein purifying the raw anode materials comprises performing a plasma purification to remove inorganic impurities or organic impurities from the raw anode materials and a activation process to generate more activated functional groups on the surface of the raw anode materials.

6. The method of claim 1, wherein generating the second anode material using the first anode material and one or more precursors comprising silicon comprises at least one of:
coating the one or more precursors comprising silicon on the first anode material or embedding the one or more precursors comprising silicon in the first anode material.

7. The method of claim 6, wherein the one or more precursors comprising silicon comprise Si or SiOₓ particles with a diameter of 1 nm-1000 nm.

8. The method of claim 6, wherein the one or more precursors comprising silicon comprise at least one of trimethylsilanol, hexamethyldisiloxane, hexamethylcyclotrisiloxane, tetramethyldisiloxane, triethylsilanol, octamethyltrisiloxane, decamethyltetrasiloxane, hexamethyldisiloxane, silane, dichlorosilane, trichlorosilane, or silicon tetrachloride.

9. The method of claim 1, further comprising: processing the second anode material in a thermal process under a controlled atmosphere.

10. The method of claim 9, wherein the controlled atmosphere comprises at least one of H₂, N₂ or Ar.

11. The method of claim 1, wherein generating the second anode material using the purified raw anode materials further comprises performing surface activation on the purified raw anode materials prior to synthesizing the second anode material using the first anode material and one or more precursors comprising silicon.

12. The method of claim 11, wherein performing surface activation on the purified raw anode materials comprises:
adding functional groups on the first anode material.

13. The method of claim 11, wherein performing surface activation on the purified raw anode materials further comprises producing porous graphite anode materials using the purified raw anode materials.

14. The method of claim 13, wherein synthesizing the second anode material using the first anode material and the one or more precursors comprising silicon comprises generating the second anode material by processing the surface-activated anode materials with the one or more precursors comprising silicon in a thermal process.

15. The method of claim 14, wherein a thermal treatment temperature of the thermal process is between about 700° C. and about 2000° C., and wherein an atmosphere gas in the thermal process comprises at least one of H₂, N₂ or Ar.

16. The method of claim 1, further comprising regenerating the first anode material contained in the raw anode materials by processing the purified raw materials in a thermal process.

17. The method of claim 16, wherein a thermal treatment temperature of the thermal process is between about 700° C. and about 2000° C., and wherein an atmosphere gas in the thermal process comprises at least one of H₂, N₂ or Ar.

18. A system for battery recycling, comprising:
a purification module that purifies raw anode materials comprising a first anode material, wherein the raw anode materials are produced from spent batteries, and wherein the first anode material comprises graphite; and
an anode material generator that generates a second anode material using the purified raw anode materials, wherein the anode material generator synthesizes the second anode material using the first anode material and one or more precursors comprising silicon, wherein the second anode material comprises a graphite-silicon composite.

19. The system of claim 18, wherein the second anode material comprises at least one of a Gr-Si composite or a Gr-SiOₓ composite.

20. The system of claim 19, wherein the anode material generator further performs surface activation on the purified raw anode materials prior to synthesizing the second anode material using the first anode material and one or more precursors comprising silicon.
